(19) United States
(12) Patent Application Publication
(10) Pub. No.: US 2025/0299065 A1
(43) Pub. Date: Sep. 25, 2025

(54) ANONYMOUSLY GENERATING AN ANALYSIS OF A STUDENT FROM VARIOUS SMALL DATASETS

(71) Applicant: RedCritter Corp., Flower Mound, TX (US)

(72) Inventors: Randy M. Whelan, Coppell, TX (US); Erika D. Lambert, Flower Mound, TX (US); Robert M. Beaty, Flower Mound, TX (US); James L. Rockett, Jr., Carrollton, TX (US); Clyde H. Forland, III, Dallas, TX (US)

(21) Appl. No.: 18/610,815

(22) Filed: Mar. 20, 2024

(51) Int. Cl. G06N 5/02; G06Q 50/20

(52) U.S. Cl. CPC G06N 5/02; G06Q 50/205

(57) ABSTRACT

An analysis of a student can be anonymously generated from various small datasets. The analysis can address the student's behavior, emotions, effort and/or achievement relative to other students without jeopardizing the privacy of the students. An educational system can provide an interface by which an educator can request an analysis for a student and can aggregate applicable data from the various small datasets to generate a prompt. The prompt can be submitted to a large language model to generate the analysis. The educational system can then return the analysis to the educator.

### CROSS-REFERENCE TO RELATED APPLICATIONS

N/A

### BACKGROUND

Educators desire a way to obtain a holistic view of a student's academic performance, mental state, motivators and outcomes. Yet, most schools do not collect sufficient data to generate such a view using traditional approaches such as machine learning. Even if schools do collect sufficient data, the data is oftentimes stored in small datasets spanning disparate systems thus making it difficult or unrealistic to leverage the data. Furthermore, for privacy reasons, schools oftentimes cannot share the data outside of the educational environment.

### BRIEF SUMMARY

Embodiments of the present disclosure are generally directed to anonymously generating an analysis of a student from various small datasets. The analysis can address the student's behavior, emotions, effort and/or achievement relative to other students without jeopardizing the privacy of the students. An educational system can provide an interface by which an educator can request an analysis for a student and can aggregate applicable data from the various small datasets to generate a prompt. The prompt can be submitted to a large language model to generate the analysis. The educational system can then return the analysis to the educator.

In some embodiments, a method may be implemented by an educational system for anonymously generating an analysis of a student from small datasets. A request for an analysis of a student can be received from an educator. The request can identify the student and a plurality of peers of the student. A plurality of small datasets that contain data pertaining to the student and the peers can be identified. One or more dataset queries can be generated to retrieve the data pertaining to the student and the peers from the plurality of small datasets. Textual content sections can be dynamically generated from the data pertaining to the student and the peers. A prompt that includes the dynamically generated textual content sections and predefined textual content that describes the educational system can be built. The prompt can be submitted to a large language model to cause the large language model to generate the analysis from the prompt. The analysis can then be presented to the educator.

In some embodiments, a method may be implemented by an educational system for anonymously generating an analysis of a student from small datasets. A request for an analysis of a student can be received from an educator. The request can identify the student and a plurality of peers of the student. A school that the student attends can be identified. A set of functionality that the school uses within the educational system can be determined. Based on the set of functionality that the school uses within the educational system, one or more dataset queries can be generated to retrieve data pertaining to the student and the peers from small datasets corresponding to the set of functionality. Textual content sections can be dynamically generated from the data pertaining to the student and the peers. Predefined textual content that describes the set of functionality the school uses within the educational system can be selected. A prompt that includes the dynamically generated textual content sections and predefined textual content that describes the set of functionality the school uses within the educational system can be built. The prompt can be submitted to a large language model to cause the large language model to generate the analysis from the prompt. The analysis can then be presented to the educator.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

These drawings depict only example embodiments and should not be considered limiting of the scope of the disclosed embodiments.

FIG. 1 illustrates an example computing environment in which one or more embodiments may be implemented.

FIGS. 2A-2F provide an example of how an analysis of a student can be anonymously generated from various small datasets.

FIG. 3 provides an example of an analysis that may be generated using one or more embodiments of the present disclosure.

### DETAILED DESCRIPTION

In this specification and the claims, the term “school” will be used to represent any educational or learning institute that may use one or more educational systems that maintain datasets that may be leveraged in embodiments of the present disclosure. The term “student” will be used to represent an individual that may attend or otherwise participate in a school for educational or learning purposes. The term “educator” will be used to represent a teacher, administrator, or other individual who is involved with a student's education at a school. The term “educational system” will be used to represent a software system used in a school for educational purposes. An example of an educational system is RedCritter's CritterCoin.

The educational system(s) employed by a school may generate/maintain various datasets pertaining to the students. These datasets could include emotion datasets, rewards datasets, parental engagement datasets, structured assignments datasets, virtual interaction datasets, and/or educator notes datasets, among possibly others.

In some embodiments, an emotion dataset can include each student's self-reported emotions at particular times. For example, an educational system may provide a user interface in which a student can input his or her emotions at any time such as by selecting from among various emoticons which may be associated with an emotion score. The student's emotion could then be stored with a timestamp to enable educators to monitor the student's mood in real-time or to review historical reports. In such a case, an emotion dataset could include, for each time a student reported his or her emotion, an indication of the reported emotion and a time when the reported emotion was reported.

In some embodiments, a rewards dataset can define achievements that each student has received and rewards that each student has purchased within an educational system. For example, an educational system could implement an achievement platform by which educators can award students for their positive behavior (e.g., in the form of badges, coins, etc.) and a rewards store in which students can purchase rewards using virtual currency associated with the awards they receive. The rewards store can include a variety of reward types such as physical items (e.g., school merchandise or candy), virtual items (e.g., a virtual pet or virtual opportunity), benefits (e.g., extra computer time or an opportunity to make a choice for the class), etc. In such a case, the rewards dataset could include, for each achievement that has been awarded to a student, an indication of the achievement and a time when the achievement was awarded. The rewards dataset may also include, for each time a student purchased a reward, an indication of the purchased reward and a time when the reward was purchased.

In some embodiments, a parental engagement dataset can define engagements that each student's parent(s) (or guardian(s)) have had in the student's education within the context of the educational system. For example, an educational system can send a periodic (e.g., daily) communication/notification to the parents that informs the parents of an activity their student must complete to earn an award (or “parental engagement award”). If the parents provide input confirming that the student performed the activity, the student can be given the parental engagement award. In some embodiments, the parental engagement dataset can represent a subset of (or customization to) the rewards dataset. In other words, when a parental engagement dataset is available, it can define which of the awards in the rewards store dataset should be considered parental engagement awards.

In some embodiments, a structured assignments dataset can define structured assignments that students may voluntarily complete (as well as those that the student must complete). In some embodiments, a structured assignment can be in the form of a workflow of learning activities through which a student may work. U.S. patent application Ser. No. 18/450,992, which is incorporated by reference, describes various examples of how structured assignments can be implemented in an educational system. In such cases, a structured assignment dataset could define each structured assignment that the student has voluntarily participated in and a timestamp representing when the student participated in the structured assignment.

In some embodiments, a virtual interaction dataset can define awards that students can earn in a virtual environment. For example, the virtual environment can allow students to have virtual pets such as is described in U.S. patent application Ser. No. 18/438,778 which is incorporated by reference. Educators can cause these pets to request specific awards that students can obtain by exhibiting desired behaviors (or “pet-desired awards”). In such cases, the virtual interaction dataset can represent a subset of (or customization to) the rewards dataset. In other words, when a virtual interaction dataset is available, it can define which of the awards in the rewards store dataset should be considered pet-desired awards.

In some embodiments, an educator notes dataset can include any notes an educator has provided for a student. For example, an educational system may provide a user interface in which an educator can input notes about a particular student. Such a note could define a positive characteristic of the student, an issue the student is having, something that the student needs to improve, etc. In such a case, an educator dataset could include, for each student, any note an educator has input for the student and a timestamp of when the note was input.

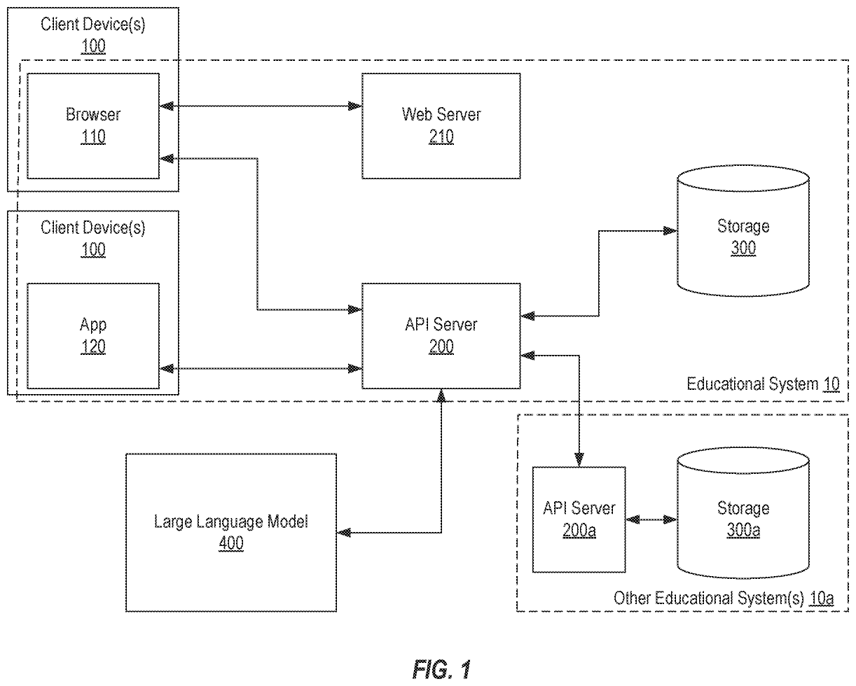

FIG. 1 provides an example of a computing environment in which embodiments of the present disclosure may be implemented. This environment includes an educational system 10 that may include an API server (or servers) 200, possibly a web server (or servers) 210, and storage 300. Users of client devices 100 may use a browser 110 to access web-based content provided by web server 210 and/or may use an app 120. In either case, the web-based content hosted in browser 110 or app 120 may interface with API server 200. Web-based content, app 120 or other software components on the client side will be referred to generally as client-side components. Of primary relevance to embodiments of the present disclosure, the client-side components are configured to enable an educator to request, via API server 200, an analysis of a student from various small datasets.

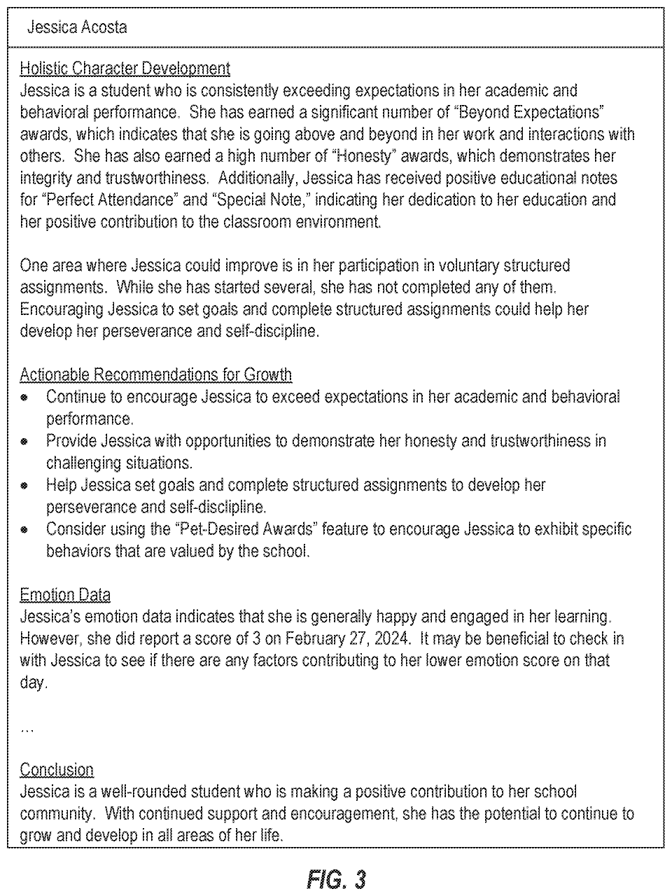

API server 200 can provide a number of APIs 201 (see FIG. 3) by which client devices 100 can interface with educational system 10 to implement functionality described herein. In this context, the term API should be construed broadly as encompassing an interface for receiving any type of communication for performing the functionality described herein. Likewise, the term API server should be construed as encompassing any service that is capable of performing the functionality described herein.

Storage 300 can represent any type or number of storage mechanisms for storing the data structures that educational system 10 may use, including some or all of the small datasets from which a student analysis may be generated. For example, storage 300 may include relational databases, object storage, indexes, file systems, etc. Any or all of API server 200, web server 210, and storage 300 can be hosted in the cloud, implemented on dedicated hardware or provided in any other suitable manner.

Client device(s) 100 can represent any computing device that a user may use to interface with educational system 10. For example, a client device 100 may be a desktop, laptop, tablet, smart phone, virtual reality headset, television, etc. In typical implementations, there may be many schools that use educational system 10, and therefore, there may be many client devices 100 that users associated with such schools use to access educational system 10.

FIG. 1 also represents that, in some embodiments, one or more other educational systems 10a may include an API server 200a and storage 300a in which one or more of the various small datasets may be maintained. In such cases, API server 200 may be configured to interface with API server 200a to access the small datasets maintained in storage 300a.

FIG. 1 also shows that API server 200 can interface with a large language model (LLM) 400. As described in detail below, API server 200 can be configured to create a prompt using the various small data sets and to submit the prompt to LLM 400 to receive an analysis of a student.

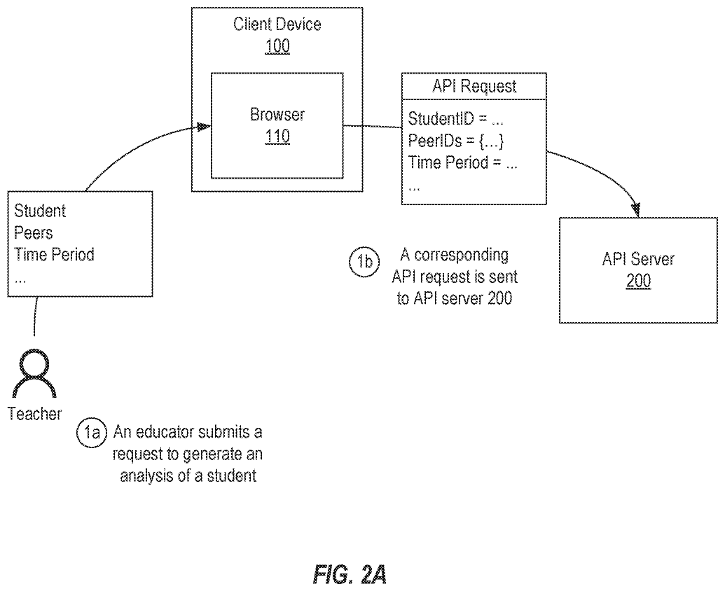

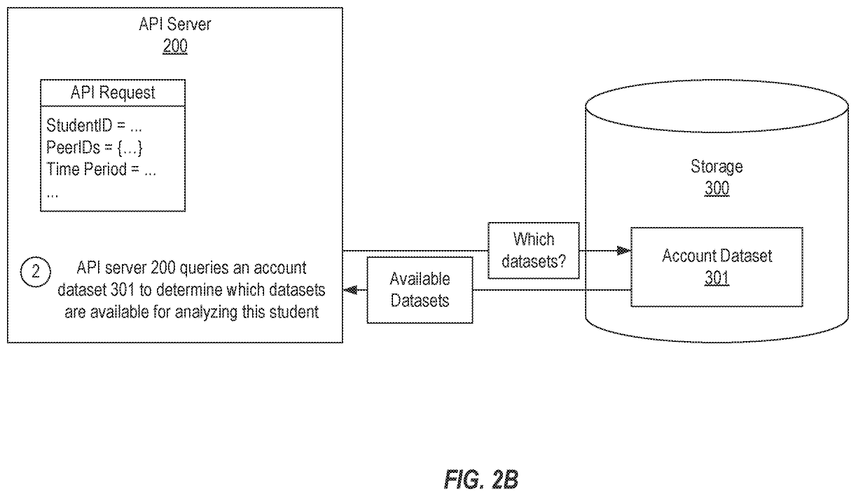

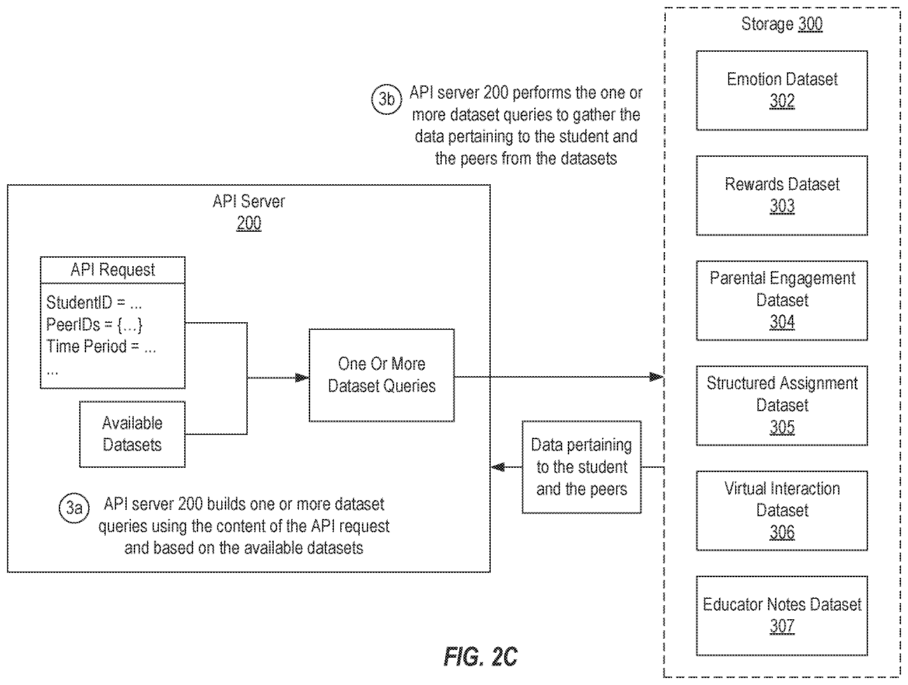

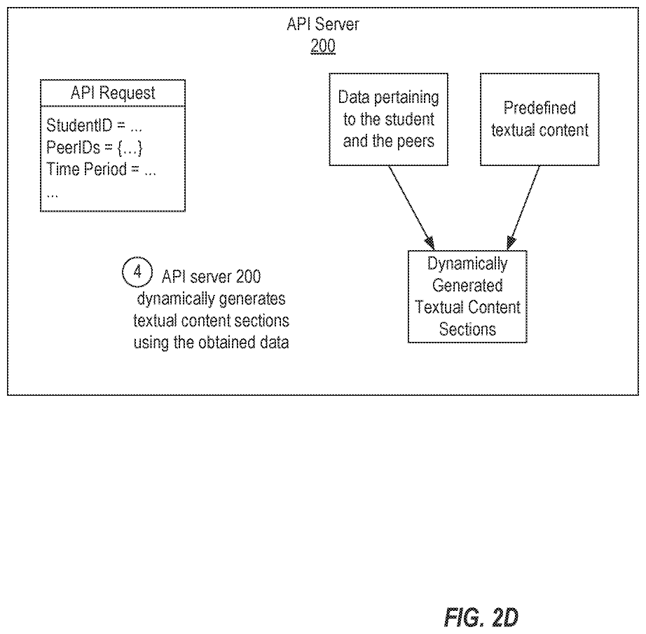

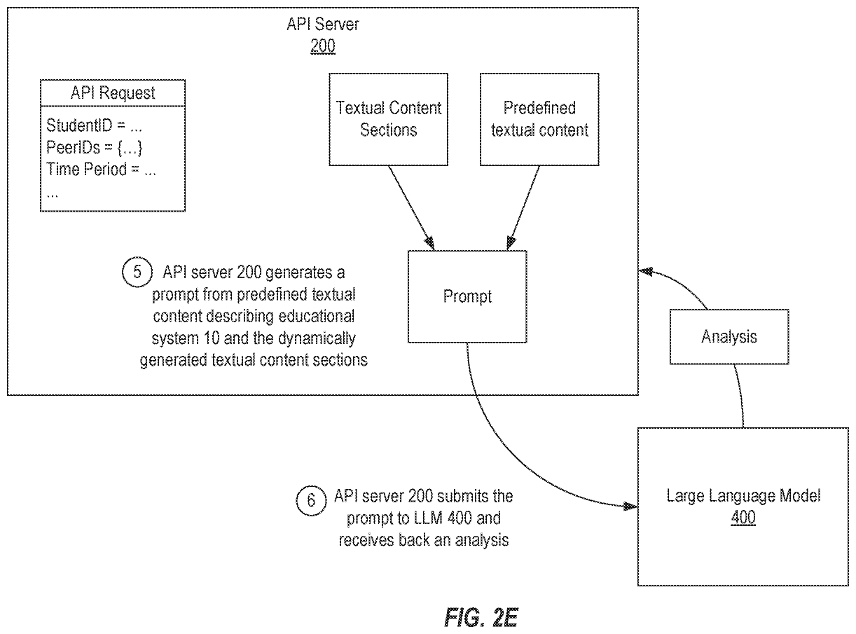

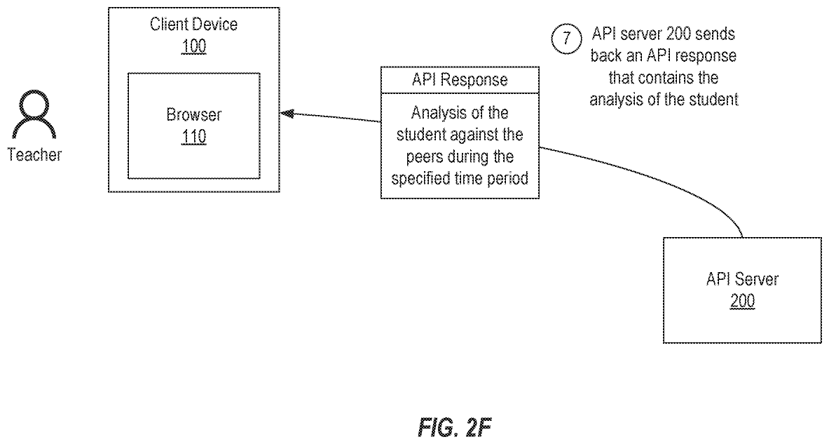

FIGS. 2A-2F provide an example of how educational system 10 can anonymously generate an analysis of a student from various small datasets in accordance with one or more embodiments of the present disclosure. For simplicity, it will be assumed in this example that all the small datasets are maintained by educational system 10. However, similar functionality could be performed when at least some of the small datasets are maintained by one or more other educational systems 10a.

Turning to FIG. 2A, in step 1a, it is assumed that an educator (e.g., a teacher) has accessed the client-side components via browser 110 to submit a request to generate an analysis for a particular student. For example, the teacher could access a webpage that allows the teacher to select a particular student for whom the analysis is to be generated, a number of peers against whom the particular student is to be analyzed (e.g., students in the same grade, students in a same class, or any other grouping of students the educator may desire), and a time period to which the analysis should be limited (e.g., the past month, the past term, the current school year, etc.), among possibly other input. In step 1b and in response to the teacher's input, the client-side components can send an API request to API server 200. This API request can define an identifier for the selected student (e.g., the StudentID in educational system 10 of the student for whom the analysis is to be generated), identifiers for the selected peers (e.g., the StudentIDs in educational system 10 of the students against whom the analysis of the student should be performed), and the time period (e.g., start and stop times), among possibly other input such as a prompt to be used when generating the analysis and a session ID by which the request can be validated (e.g., to determine a school to which the request pertains).

Turning to FIG. 2B, in step 2, API server 200 can initially process the API request by determining which datasets are available for use in generating an analysis of the student. For example, using a session ID defined in the API request, API server 200 could determine which school the student attends and could then query an account dataset 301 (e.g., using a school/organization ID) to determine which datasets educational system 10 maintains for the school (or has access to via another educational system 10a). For example, as part of step 2, API server 200 could determine that the school that the student attends uses educational system 10 to obtain self-reported emotions from its students, to implement a rewards system, to engage with parents, to provide structured assignments, to provide a virtual environment, and to track educator notes such that an emotion dataset, a rewards dataset, a parental engagement dataset, a structured assignments dataset, a virtual interaction dataset, and an educator notes dataset are available for generating an analysis for students of the school. In cases where any of such datasets are available via another educational system 10a, step 2 could entail obtaining an identification of the other educational system 10a and any information necessary for accessing the other educational system 10a (e.g., identifiers for the student and peers in the other educational system 10a).

Turning to FIG. 2C, in step 3a, API server 200 can build one or more dataset queries using the content of the API request and based on the datasets that are available for analyzing the student. For example, using the identifiers for the student and peers and the defined time period, API server 200 could build one or more queries for retrieving data pertaining to the student and the peers from any or all of emotion dataset 302, rewards dataset 303, parental engagement dataset 304, structured assignment dataset 305, virtual interaction dataset 306, and educator notes dataset 307.

In some embodiments, the data obtained from emotion dataset 302 can include each self-reported emotion made by the student during the specified time period and each self-reported emotion made by each of the peers during the specified time period. In some embodiments, an emotion can be associated with a score (e.g., on a scale of 1-5 where 1 is most negative and 5 is most positive).

In some embodiments, the data obtained from rewards dataset 303 can include each award issued to and reward purchased by the student during the specified time period and each award issued to and reward purchased by each peer during the specified time period. In some embodiments, the data obtained from rewards dataset 303 (or possibly from another dataset such as account dataset 301) could also include a definition of each award (e.g., a desired behavior that is associated with an award) which can allow API server 200 to determine what the award represents.

In some embodiments, the data obtained from parental engagement dataset 304 can include an identification of each time the student completed or failed to complete the activity associated with a parental engagement that was requested during the specified time period and an identification of each time each peer completed or failed to complete the activity associated with a parental engagement that was requested during the specified time. In some embodiments, the data obtained from parental engagement dataset 304 could be in the form of an identification of whether an award is a parental engagement award. In such cases, the data obtained from parental engagement dataset 304 could be used to determine whether an award included in the data obtained from rewards dataset 303 represents the student's or peer's completion of a parental engagement activity.

In some embodiments, the data obtained from structured assignment dataset 305 can include an identification of each structured assignment the student participated in during the specified time period and an identification of each structured assignment each peer participated in during the specified time period.

In some embodiments, the data obtained from virtual interaction dataset 306 can include an identification of each pet-desired award that has been offered to the student's pet(s) and an identification of each pet-desired award that has been offered to each peer's pet(s). In such cases, the data obtained from virtual interaction dataset 306 could be used to determine whether an award included in the data obtained from rewards dataset 303 represents that the student or peer exhibited the desired behavior to obtain the pet-desired award.

In some embodiments, the data obtained from educator notes dataset 307 can include each note an educator has provided for the student and each note an educator has provided for each of the peers. In embodiments where educator notes are selected from predefined options (or flags), the data obtained from educator notes dataset 307 could also include a definition of each defined option.

In step 3b, API server 200 can perform the one or more dataset queries to gather the data pertaining to the student and the peers from the available datasets. In some embodiments, API server 200 may structure the one or more dataset queries to build separate tables for temporarily storing the different types of data (e.g., a table for storing the definitions of the awards the school makes available, a table for storing the awards the student and peers have been given, a table for storing the rewards the student and peers have purchased, etc.).

Turning to FIG. 2D, in step 4a, API server 200 can dynamically generate textual content sections from the data pertaining to the student and the peers during the specified time period which it obtained from the various small datasets. These dynamically generated textual content sections can subsequently be used to build a prompt as described in detail below. In some embodiments, API server 200 can also use the available datasets to determine which predefined textual content sections are applicable (e.g., by considering a description of structured assignments only when a structured assignment dataset is available). In the examples below, the [ . . . ] is intended to represent portions of the textual content that is dynamically generated from the data obtained from the datasets.

In some embodiments, API server 200 can dynamically generate one or more sentences (or other textual structures) describing background information for the school to which the student and peers pertain. For example, these sentences could describe the awards the school makes available to its students such as a description of each award and its rarity (e.g., how difficult it is to earn the award) and/or could describe the educator notes the school allows educators to provide such as a description of each type of educator note and whether it is positive or negative. An example of how this background information may be structured is as follows:
“Award descriptions can sometimes provide more insight into how the students earned the award. Award rarity is an indicator of how difficult it is for students to earn the award. The rarities from least rare to most rare are: Common, Rare, Exclusive, Unique. This school has created the following awards: [ . . . ]”
“When a student earns a positive educator note, that indicates a positive interaction. When students earn a negative educator note, that indicates a negative, undesired, interaction. This school has created the following educator notes: [ . . . ]”

In some embodiments, API server 200 can use the data obtained from emotion dataset 302 to dynamically generate one or more sentences describing/listing each emotion the student has self-reported during the specified time period (e.g., by listing an associated emotion score with the date/time when the student reported the emotion). In some embodiments, API server 200 can also generate one or more sentences comparing an average emotion score for the student to an average emotion score for the peers. An example of how this emotion content may be structured is as follows:
“Here is a log of the Emotion Scores self-reported by this student for the time period: [ . . . ] For the entire time period, the student reported an Emotion Score of [ . . . ], whereas the peers on average reported an Emotion Score of [ . . . ]”

In some embodiments, API server 200 can use the data obtained from rewards dataset 303 to dynamically generate one or more sentences describing the number of awards the student has received during the specified time period and the average number of awards the peers have received during the specified time period. In some embodiments, API server 200 can also use the data obtained from rewards dataset 303 to generate one or more sentences describing the number of rewards the student has purchased during the specified time period and the average number of rewards the peers have purchased during the specified time period. An example of how this awards and rewards content may be structured is as follows:
“The student received [ . . . ] awards during the time period [ . . . ], whereas the peers received an average of [ . . . ] awards during the time period. The student purchased [ . . . ] rewards from the school's reward store during the time period, whereas the peers purchased on average [ . . . ] rewards from the school's rewards store during the time period.”

In some embodiments, API server 200 can use the data obtained from parental engagement dataset 304 (possibly in conjunction with the data obtained from rewards dataset 303) to dynamically generate one or more sentences describing the number of parental engagements (e.g., the associated activity) the student attempted and/or successfully completed during the specified time period and one or more sentences describing the average number of parental engagements the peers attempted and/or successfully completed during the specified time period. An example of how this parental engagement content may be structured is as follows:
“The student received [ . . . ] parental engagement awards during the time period [ . . . ], whereas the peers received an average of [ . . . ] parental engagement awards during the time period. The student attempted but failed to receive [ . . . ] parental engagement awards during the time period [ . . . ], whereas the peers attempted but failed to receive on average [ . . . ] parental engagement awards during the time period.”

In some embodiments, API server 200 can use the data obtained from structured assignment dataset 305 to dynamically generate one or more sentences describing the number of structured assignments the student started and successfully completed during the specified time period and one or more sentences describing the average number of structured assignments the peers started and successfully completed during the specified time period. An example of how this structured assignment content may be structured is as follows:
“The student started [ . . . ] voluntary structured assignments and successfully completed [ . . . ] of them, whereas the peers started on average [ . . . ] voluntary structured assignments and successfully completed on average [ . . . ] of them.”

In some embodiments, API server 200 can use the data obtained from virtual interaction dataset 306 to dynamically generate one or more sentences describing the number of virtual interactions the student completed during the specified time period and one or more sentences describing the average number of virtual interactions the peers completed during the specified time period. An example of how this virtual interaction content may be structured is as follows:
“The student successfully completed [ . . . ] out of [ . . . ] desired virtual interaction requests during the time period, whereas the peers successfully completed on average [ . . . ] out of [ . . . ] desired virtual interaction requests during the time period.”

In some embodiments, API server 200 can use the data obtained from educator notes dataset 307 to dynamically generate one or more sentences describing the educator notes the student received during the specified time period and one or more sentences describing the average number of educator notes the peers received during the specified time period. An example of how this educator notes content may be structured is as follows:
“Here is a list of the educator notes the student has received during the time period: [ . . . ]. In comparison, the peers received an average of [ . . . ] educator notes during the time period. Of the educator notes the student has received, only the following are currently active, any others have been resolved or removed: [ . . . ]”

Turning to FIG. 2E, in step 5, API server 200 can generate a prompt from the dynamically generated textual content sections and from additional predefined textual content. For example, in some embodiments, API server 200 may maintain predefined textual content that describes how educational system 10 works (and how any other educations system 10a from which data was obtained works) and such content may be dynamically selected based on which datasets are available for the analysis of the particular student. API server 200 may aggregate the dynamically selected predefined textual content with the dynamically generated textual content sections to create a prompt that is customized for the analysis of the particular student against the peers.

An example of predefined textual content that may be dynamically selected for inclusion in the prompt when educational system 10 makes all datasets available for the analysis of a student is as follows:
“The educational system is a platform that helps improve and measure student achievement, effort, recognition, participation and behaviors. With the educational system, schools create digital awards representing positive behaviors the school wants to reward. When a student exhibits a positive behavior, teachers send the award representing that behavior to the student as recognition. Awards have point values. When a student earns an award, the student's reward store balance increases by the award's point value. Students can spend their reward points in the school's reward store. Schools can define the rewards and their cost. When students purchase rewards with their reward points, it is an indicator that they are engaged and demonstrating positive behaviors because reward points can only be earned by receiving awards. Students can receive awards in different ways including directly from their teachers, by completing activities associated with parental engagements, and as part of virtual interactions.”
“In the educational system, awards have a rarity. The more rare an award is, the more significant it is. An award with a unique rarity is typically given to a single student.”
“The educational system also has educator notes. Schools can define their educator notes, and then educators can assign the educator notes to a student to indicate something positive or negative. Educators can assign negative educator notes to students to indicate a potential issue or something that needs improvement. Educators can assign positive educator notes to students to indicate the student is exhibiting positive effort, achievement, or behavior. Educator notes are only visible for educator's internal use. Students and parents cannot see them.”
“The educational system also collects self-reported emotion data from students about how they feel overall. Students choose an emotion score from 1-5 with 1 being very unhappy, 3 being neutral, and 5 being very happy. If the student has emotion data indicating a pattern of unhappiness, please review it. If the student's emotion data is vastly different than their peers' emotion data, please analyze it.”
“The educational system also has structured assignments which are workflows that students can navigate that usually involve learning activities. Educators can send structured assignments to students. Students can also volunteer for any structured assignments that is marked as voluntary.”
“Some awards can only be earned through parental engagement. These parental engagement awards are earned when a student's parent confirms that the student performed an associated activity at home. Parental engagement awards help educators drive specific student behavior out of school and encourages parental involvement.”
“The educational system also has pets that students can interact with virtually. Students can spend their reward points to buy various pets. Once they own a pet, they can buy the pet food from the reward store and feed it to make the pet happy. The educational system also has pet-desired awards. Teachers can choose a pet-desired award and send it to a selected student's pet. This causes the pet to ask the student to earn the pet-desired award. If the student earns the pet-desired award from the educator within 24 hours, the pet gains experience points. Since an educator sends a pet-desired award to the pet to identify a behavior the educator wants the student to exhibit, if the student earns the pet-desired award, it indicates that the student successfully demonstrated that behavior.”

API server 200 could append each dynamically generated textual content section to this dynamically selected predefined textual content to complete the prompt. For example, API server 200 could append “Here is the data collected from the school for the student and peers” followed by each of the dynamically generated textual content sections. In some embodiments, API server 200 could also append instructions of “If there are any strong trends in the student's emotions, please analyze that,” and/or “please format your response as HTML,” among possibly other instructions to facilitate the creation of the analysis.

In step 6, API server 200 can submit the prompt to LLM 400 and then receive back a corresponding analysis. In some embodiments, LLM 400 may use natural language processing techniques to generate the analysis from the textual content of the prompt. Notably, because the dynamically generated textual content sections included anonymized data, LLM 400 does not receive and does not use the identity of any student in generating the analysis. API server 200 can parse the analysis as appropriate and format its content for presentation.

Finally, turning to FIG. 2F, in step 7, API server 200 can complete its handling of the API request by returning an API response that contains the analysis. The client-side components could then present the analysis to the teacher or other educator.

FIG. 3 provides an example of how an analysis may appear when presented to an educator. The analysis includes AI-generated insights and recommendations that are based on the student's performance relative to her peers but were generated anonymously using the techniques described above.

As can be seen, embodiments of the present disclosure enable a meaningful analysis of a student to be anonymously generated using various small datasets and without comprising privacy. The analysis can be used to generate more detailed and helpful learning profiles for the student and for the school's use of the educational software. The analysis may also be used for early detection of any emotional issues a student may be facing.

Embodiments of the present disclosure may comprise or utilize special purpose or general-purpose computers including computer hardware, such as, for example, one or more processors and system memory. Embodiments within the scope of the present disclosure also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present disclosure can be hosted in a cloud environment.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by an educational system, for anonymously generating an analysis of a student from small datasets, the method comprising:
receiving, from an educator, a request for an analysis of a student, the request identifying the student and a plurality of peers of the student;
identifying a plurality of small datasets that contain data pertaining to the student and the peers;
generating one or more dataset queries to retrieve the data pertaining to the student and the peers from the plurality of small datasets;
dynamically generating textual content sections from the data pertaining to the student and the peers;
building a prompt that includes the dynamically generated textual content sections and predefined textual content that describes the educational system;
submitting the prompt to a large language model to cause the large language model to generate the analysis from the prompt; and
presenting the analysis to the educator.

2. The method of claim 1, wherein the request specifies a time period and the one or more dataset queries are configured to cause the data pertaining to the student and the peers to be limited to the time period.

3. The method of claim 1, wherein the plurality of small datasets are maintained by the educational system.

4. The method of claim 1, wherein at least one of the small datasets is maintained by another educational system.

5. The method of claim 1, wherein the plurality of datasets are selected from:
an emotion dataset;
a rewards dataset;
a parental engagement dataset;
a structured assignment dataset;
a virtual interaction dataset; or
an educator notes dataset.

6. The method of claim 5, wherein the plurality of datasets are selected based on functionality that the student's school uses within the educational system.

7. The method of claim 1, wherein the predefined textual content that describes the educational system is selected based on the functionality that the student's school uses within the educational system.

8. The method of claim 1, wherein the plurality of datasets include each of:
an emotion dataset;
a rewards dataset;
a parental engagement dataset;
a structured assignment dataset;
a virtual interaction dataset; and
an educator notes dataset.

9. The method of claim 1, wherein the dynamically generated textual content sections include anonymized data pertaining to the student and the peers.

10. The method of claim 1, further comprising:
parsing and formatting the analysis prior to presenting the analysis to the educator.

11. One or more computer storage media storing computer executable instructions which when executed in an educational system implement a method for anonymously generating an analysis of a student from small datasets, the method comprising:
receiving, from an educator, a request for an analysis of a student, the request identifying the student and a plurality of peers of the student;
identifying a plurality of small datasets that contain data pertaining to the student and the peers;
generating one or more dataset queries to retrieve the data pertaining to the student and the peers from the plurality of small datasets;
dynamically generating textual content sections from the data pertaining to the student and the peers;
building a prompt that includes the dynamically generated textual content sections and predefined textual content that describes the educational system;
submitting the prompt to a large language model to cause the large language model to generate the analysis from the prompt; and
presenting the analysis to the educator.

12. The computer storage media of claim 11, wherein the plurality of small datasets are maintained by the educational system.

13. The computer storage media of claim 11, wherein at least one of the small datasets is maintained by another educational system.

14. The computer storage media of claim 11, wherein the plurality of datasets are selected from:
an emotion dataset;
a rewards dataset;
a parental engagement dataset;
a structured assignment dataset;
a virtual interaction dataset; or
an educator notes dataset.

15. The computer storage media of claim 14, wherein the plurality of datasets are selected based on functionality that the student's school uses within the educational system.

16. The computer storage media of claim 11, wherein the predefined textual content that describes the educational system is selected based on the functionality that the student's school uses within the educational system.

17. The computer storage media of claim 11, wherein the dynamically generated textual content sections include anonymized data pertaining to the student and the peers.

18. A method, implemented by an educational system, for anonymously generating an analysis of a student from small datasets, the method comprising:
receiving, from an educator, a request for an analysis of a student, the request identifying the student and a plurality of peers of the student;
identifying a school that the student attends;
determining a set of functionality the school uses within the educational system;
based on the set of functionality the school uses within the educational system, generating one or more dataset queries to retrieve data pertaining to the student and the peers from small datasets corresponding to the set of functionality;
dynamically generating textual content sections from the data pertaining to the student and the peers;
selecting predefined textual content that describes the set of functionality the school uses within the educational system;
building a prompt that includes the dynamically generated textual content sections and predefined textual content that describes the set of functionality the school uses within the educational system;
submitting the prompt to a large language model to cause the large language model to generate the analysis from the prompt; and
presenting the analysis to the educator.

19. The method of claim 1, wherein the small datasets corresponding to the set of functionality are selected from among:
an emotion dataset;
a rewards dataset;
a parental engagement dataset;
a structured assignment dataset;
a virtual interaction dataset; or
an educator notes dataset.

20. The method of claim 19, wherein the small datasets corresponding to the set of functionality include each of:
an emotion dataset;
a rewards dataset;
a parental engagement dataset;
a structured assignment dataset;
a virtual interaction dataset; and
an educator notes dataset.
